(19) United States
(12) Patent Application Publication
(10) Pub. No.: US 2026/0316168 A1
(43) Pub. Date: Oct. 15, 2026

(54) CUTTING INSERT WITH COOLING CHANNEL FEATURE

(71) Applicant: No Screw Ltd., Hevel Modi'in (IL)

(72) Inventor: Gershon HARIF, Ramat Gan (IL)

(21) Appl. No.: 19/491,499

(22) PCT Filed: Jun. 3, 2024
(86) PCT No.: PCT/IL2024/050546

§ 371 Date: Dec. 9, 2025

Related U.S. Application Data
(60) Provisional application No. 63/522,352, filed on Jun. 21, 2023.

(51) Int. Cl. B23C 5/28; B23C 5/20

(52) U.S. Cl. CPC B23C 5/282; B23C 5/20; B23C 5/286; B23C 2200/0455; B23C 2200/121; B23C 2250/12

(57) ABSTRACT

A cutting insert includes a corner cutting region and a cooling channel formed in a wall cavity. The cutting insert includes a body having an upper insert surface, a lower insert surface defining a lower insert plane, and at least one sidewall extending therebetween. The corner cutting region is defined between the at least one sidewall and the upper insert surface. The at least one sidewall is formed with at least one cooling channel formed in a wall cavity defining a coolant flow’ path having an upstream section with a coolant inlet facing the lower insert plane. The coolant flow’ path further has a downstream section extending beneath the corner cutting region. The coolant flow’ path is at least partially exposed to an exterior of the cutting insert and includes an arcuate portion between the upstream section and the downstream section.

### TECHNOLOGICAL FIELD

The presently disclosed subject matter generally relates to cutting tools and cutting inserts, and in particular to cutting tools and cutting inserts comprising external cooling channels.

### BACKGROUND ART

References considered to be relevant as background to the presently disclosed subject matter are listed below:
U.S. Pat. No. 9,095,913B2
U.S. Pat. No. 9,656,323B2
US 2021/0205895A1
WO 2023/079549A1

Acknowledgement of the above references herein is not to be inferred as meaning that these are in any way relevant to the patentability of the presently disclosed subject matter.

### BACKGROUND

It is known in the art to direct a cooling fluid, i.e. coolant, to a cutting interface of a cutting tool during a cutting operation on a workpiece. Directing a coolant against interfacing of a cutting tool against a workpiece cools the cutting interface during the cutting operation, thereby preventing damage to both the cutting edge and the workpiece.

In general, cutting tools have a rake face and at least one relief or flange face, defining, at the intersection thereof, the tool's cutting edge. Cooling fluid is generally directed thereagainst, either from the side of the rake face, or from the side of the relief face, or from directions to apply coolant to both faces forming the cutting edge.

Cutting tools may also include cutting inserts, which perform the actual machining or cutting operation at the workpiece surface. Such cutting inserts are associated with cooling arrangements, separate from the cutting insert, which are configured for external provision of coolant to the cutting insert.

Conventional cutting inserts may have a cutting corner region defined between a first side surface, second side surface and one of the upper surface and a lower surface. A cooling cavity, including a cooling surface proximal to the cutting corner region, is configured for receiving therein the coolant for cooling the interface between a cutting insert and the workpiece, and thereby withdraw heat from the cutting corner region.

Typically, the entire cutting corner region is coated with a coating to increase durability; however, the coating may decrease the thermal conductivity of the cooling surface, reducing the effectiveness thereof. Accordingly, an object of the present disclosure is to increase thermal conductivity of the cooling surface by leaving the cooling surface free of the coating material, which covers the remainder of the cutting corner region.

### GENERAL DESCRIPTION

There is thus provided in accordance with an embodiment of the presently disclosed subject matter a cutting insert. The cutting insert according to the presently disclosed subject matter comprises a body having an upper insert surface, a lower insert surface defining a lower insert plane, and at least one sidewall extending therebetween. The cutting insert further comprises at least one corner cutting region defined between the at least one sidewall and the upper insert surface.

In some embodiments, the at least one sidewall is formed with at least one cooling channel defining a coolant flow path extending between an upstream section thereof having a coolant inlet facing said lower insert plane, and a downstream section thereof extending beneath said at least one corner cutting region. In some embodiments, the coolant flow path is at least partially exposed to an exterior of the cutting insert and comprises an arcuate portion between the upstream section and the downstream section.

In some embodiments, the arcuate portion is characterized by a single smooth curve along at least a portion of the coolant flow path. In some embodiments, the single smooth curve extends along a planar dimension parallel to the at least one sidewall. In some embodiments, the arcuate portion creates pressure in a coolant directed therealong thereby increasing coolant flow along the coolant flow path for increasing heat removal at the corner cutting region. In some embodiments, the arcuate portion is radiused in three dimensions at least along a portion thereof.

In some embodiments, the arcuate portion comprises a decreasing radius at least along a portion of the coolant flow path extending from the upstream section toward the downstream section corresponding to an increasing centrifugal force along the portion of the coolant flow path. In some embodiments, the single smooth curve comprises an increasing radius in a dimension transverse to the coolant flow path from the upstream section toward the downstream section.

In some embodiments, the arcuate portion extends through an arc length at least 90 degrees along the coolant flow path. In some embodiments, the arcuate portion extends through an arc length greater than 90 degrees along the coolant flow path. In some embodiments, the arcuate portion extends through an arc length within a range of 105 to 125 degrees. In some embodiments, the arcuate portion is configured to direct coolant along the coolant flow path downwardly at the corner cutting region for enhancing heat removal thereat.

In some embodiments, the cooling channel is formed in a wall cavity at least a portion of which is exposed to the exterior of the cutting insert. In some embodiments, a majority of the coolant flow path is exposed to the exterior of the cutting insert. In some embodiments, the majority of the coolant flow path is exposed toward the downstream section and a minority of the coolant flow path is enclosed toward the upstream section. In some embodiments, the coolant flow path at the upstream section is enclosed relative to the exterior. In some embodiments, the coolant flow path thereby comprises exposed and enclosed portions therealong together forming a conjoined coolant stream.

In some embodiments, the coolant flow path becomes increasingly exposed from the upstream section toward the downstream section. In some embodiments, an external wall portion encloses the coolant inlet at the upstream section. In some embodiments, the external wall portion slopes toward the arcuate portion becoming smooth therewith intermediate the upstream section and the downstream section at a smooth transition point. In some embodiments, the coolant inlet comprises an inlet radius. In some embodiments, the external wall portion is sloped relative to the coolant inlet for increasing a coolant flow path width relative to the inlet radius as coolant is directed along the coolant flow path toward the downstream section.

In some embodiments, the cooling channel further comprises an arcuate banked portion extending along the arcuate portion, which arcuate banked section is sloped from the arcuate portion toward an inner cavity surface of the wall cavity for directing coolant therealong. In some embodiments, the inner cavity surface is parallel to the coolant flow path. In some embodiments, the inner cavity surface extends in parallel relation to a sidewall surface of the sidewall.

In some embodiments, the coolant inlet comprises an inlet diameter configured to receive coolant from a coolant outlet in fluid communication therewith. In some embodiments, the coolant outlet comprises an outlet diameter corresponding to the inlet diameter. In some embodiments, the corner cutting region comprises a corner banked portion configured to redirect coolant beneath the corner cutting region.

In some embodiments, the sidewall comprises opposed sidewall portions angled relative to one another. In some embodiments, the opposed sidewall portions together define a bifurcated wall cavity beneath the corner cutting region. In some embodiments, the bifurcated wall cavity comprises opposed cooling channels in fluid communication with one another. In some embodiments, the opposed cooling channels together define a bifurcated cooling channel flow path opposed portions of which are angled relative to one another and directed toward the corner cutting region.

In some embodiments, a medial insert plane extends orthogonally relative to the upper and lower insert surfaces. In some embodiments, the bifurcated wall cavity is symmetrical about the medial insert plane. In some embodiments, the opposed cooling channels formed in the bifurcated wall cavity are symmetrical about the medial insert plane. In some embodiments, corner cutting region comprises a rake surface at the upper insert surface and a flank surface at the sidewall surface thereby providing at least one cutting edge at the upper insert surface. In some embodiments, at least one cooling channel extends from the flank surface to the lower insert surface.

In some embodiments, the comer cutting region comprises opposed cutting edges angled relative to one another. In some embodiments, the comer cutting region comprises a curved cutting edge between the opposed cutting edges. In some embodiments, the corner cutting region comprises a tapered portion above the corner banked portion in spaced relation to the curved cutting edge. In some embodiments, the body is rhombic in form having acute angles at the corner cutting region and an insert corner opposite the corner cutting region.

In some embodiments, the cooling channel is configured to oppose a workpiece during a cutting operation. In some embodiments, the workpiece comprises an inner workpiece surface. In some embodiments, the cooling channel and the inner workpiece surface together are configured to redirect coolant within a space defined therebetween.

### BRIEF DESCRIPTION OF THE DRAWINGS

Other features and objectives of the presently disclosed subject matter will become more evident from a consideration of the following brief descriptions of drawings submitted in support of these specifications.

FIG. 1 is a front top perspective view of a first cutting tool with mounted cutting insert according to the present disclosure.

FIG. 2 is a top plan view of the first cutting tool with mounted cutting insert according to the present disclosure.

FIG. 3 is a lateral elevational view of the first cutting tool with mounted cutting insert according to the present disclosure.

FIG. 4 is an exploded top perspective of the first cutting tool with the cutting insert being shown exploded from various components of the cutting tool according to the present disclosure.

FIG. 5 is a top perspective view of a cutting tool holder to which the cutting insert mounts according to the present disclosure.

FIG. 6 is a top plan view of the cutting tool holder to which the cutting insert mounts according to the present disclosure.

FIG. 7 is a front end perspective view of the cutting tool holder to which the cutting insert mounts according to the present disclosure.

FIG. 8 is a rear end perspective view of the cutting tool holder to which the cutting insert mounts according to the present disclosure.

FIG. 8 is a rear end perspective view of the cutting tool holder to which the cutting insert mounts according to the present disclosure.

FIG. 9 is a rear perspective view of the cutting tool holder to which the cutting insert mounts according to the present disclosure depicting internal structures in broken lines including a conduit for delivering coolant to the cutting insert according to the present disclosure.

FIG. 10 is a bottom perspective view of an insert seat upon which cutting insert seats according to the present disclosure.

FIG. 11 is a top perspective view of an insert seat upon which cutting insert seats according to the present disclosure.

FIG. 12 is an enlarged front top perspective view of the cutting insert depicting a cooling cavity formed therein according to the present disclosure.

FIG. 13 is a front elevational view of the cutting insert depicting a cooling cavity formed therein according to the present disclosure.

FIG. 14 is a top plan view of the cutting insert according to the present disclosure.

FIG. 15 is a bottom plan view of the cutting insert according to the present disclosure.

FIG. 16 is a fragmentary enlarged bottom perspective view of upper portions of the cooling cavity of the cutting insert, enlarged to show in greater detail features associated therewith.

FIG. 17 is an enlarged, fragmentary elevational side view of cutting insert according to the present disclosure to show in greater detail features of a cooling channel thereof.

FIG. 18 is an enlarged, fragmentary bottom view of cutting insert according to the present disclosure to show in greater detail features of a cooling channel thereof.

FIG. 19 is a front top perspective view of the cutting insert and insert seat in assembled relation with on another according to the present disclosure.

FIG. 20 is a lateral top perspective view of the cutting insert and insert seat in assembled relation with on another according to the present disclosure.

FIG. 21 is a fragmentary enlarged top perspective view of lower portions of the cooling cavity of the cutting insert enlarged to show in greater detail features associated therewith.

FIG. 22 is a bottom perspective view of the cutting insert and insert seat in assembled relation with on another juxtaposed adjacent a workpiece according to the present disclosure.

FIG. 23 is a top perspective view of the cutting insert and insert seat in assembled relation with on another juxtaposed adjacent a workpiece according to the present disclosure.

FIG. 24 is a lateral elevational view of the cutting insert and insert seat in assembled relation with on another juxtaposed adjacent a workpiece according to the present disclosure.

FIG. 25 is a top perspective view of the workpiece otherwise depicted in FIGS. 22 through 24 depicting inner surfaces thereof with partially removed chip.

FIG. 26 is a lateral elevational view of the workpiece otherwise depicted in FIGS. 22 through 25 depicting inner surfaces thereof with partially removed chip.

FIG. 27 is a side elevational view of a milling tool with an array of mounted cutting inserts according to the presently disclosed subject matter.

FIG. 28 is a top plan view of the milling tool with an array of mounted cutting inserts according to the presently disclosed subject matter.

FIG. 29 is a bottom plan view of the milling tool with an array of mounted cutting inserts mounted thereto according to the presently disclosed subject matter.

FIG. 30 is a fragmentary top perspective view of the milling tool according to the presently disclosed subject matter showing coolant inlets at an upper tool end thereof.

FIG. 31 is a bottom perspective view of the milling tool with an array of mounted cutting inserts mounted thereto according to the presently disclosed subject matter.

FIG. 32 is a first enlarged bottom perspective view of an exemplary cutting insert as mounted to the milling tool accordingly to the presently disclosed subject matter.

FIG. 33 is a second enlarged bottom perspective view of an exemplary cutting insert as mounted to the milling tool accordingly to the presently disclosed subject matter.

FIG. 34 is an enlarged bottom perspective view of an exemplary insert support portion of the milling tool with cutting insert removed therefrom to better reveal a coolant outlet formed in the insert support portion.

FIG. 35 is a third enlarged bottom perspective view of an exemplary cutting insert as mounted to the insert support portion otherwise depicted in FIG. 34 accordingly to the presently disclosed subject matter.

### DETAILED DESCRIPTION OF THE EMBODIMENTS

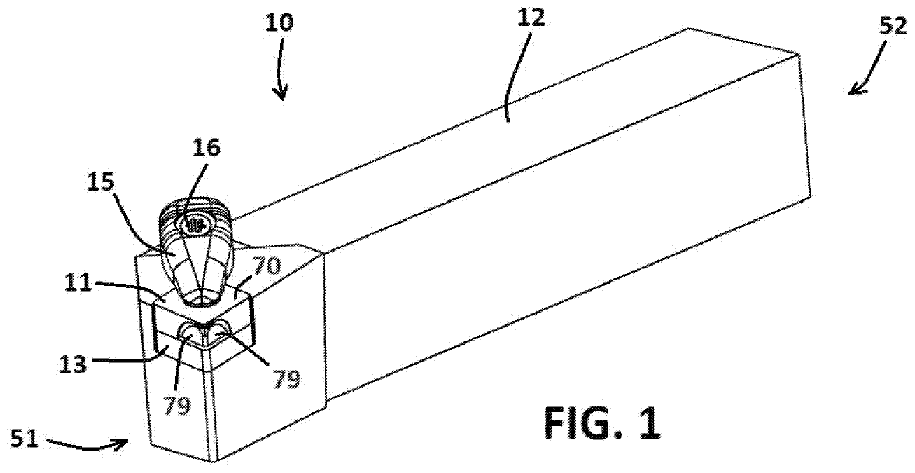

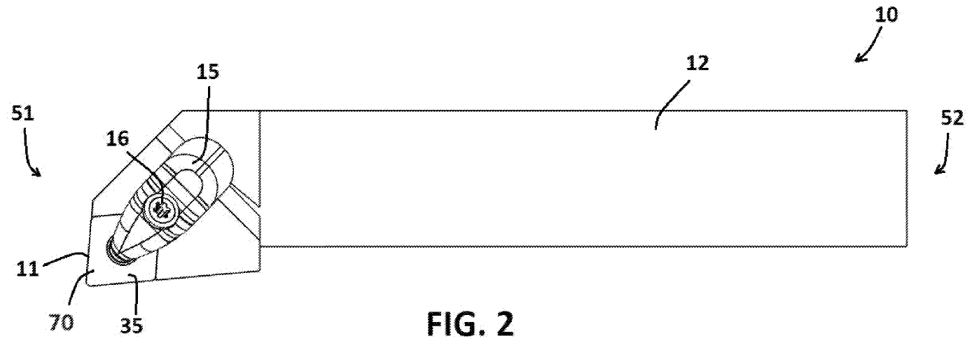

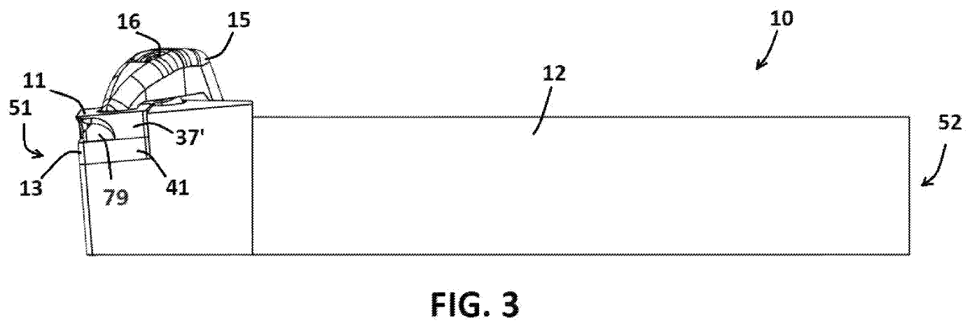

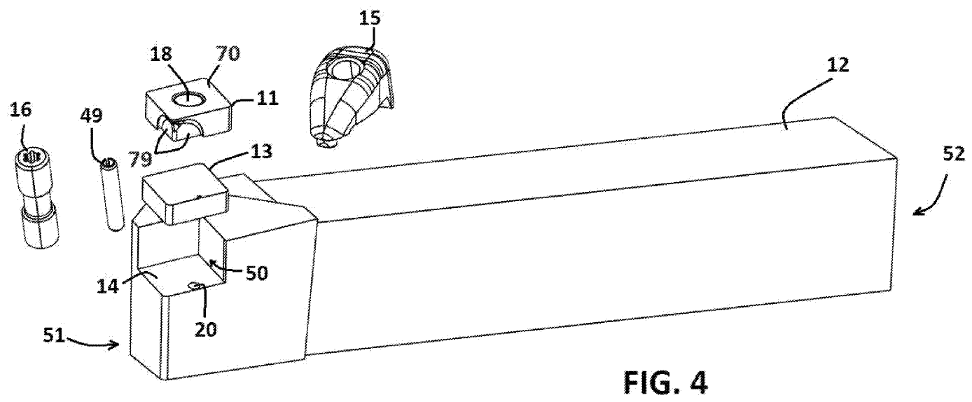

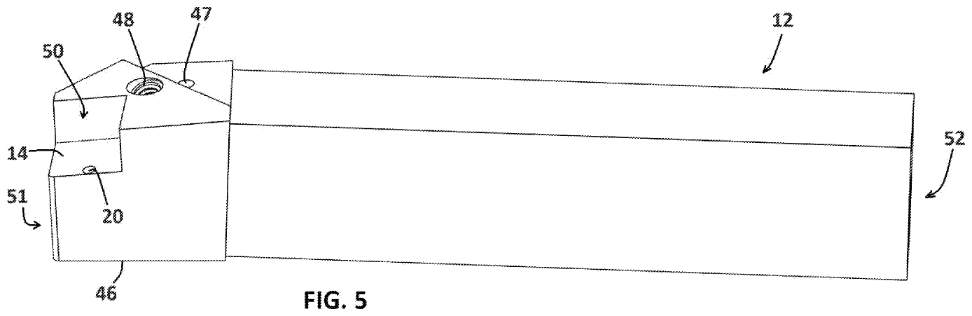

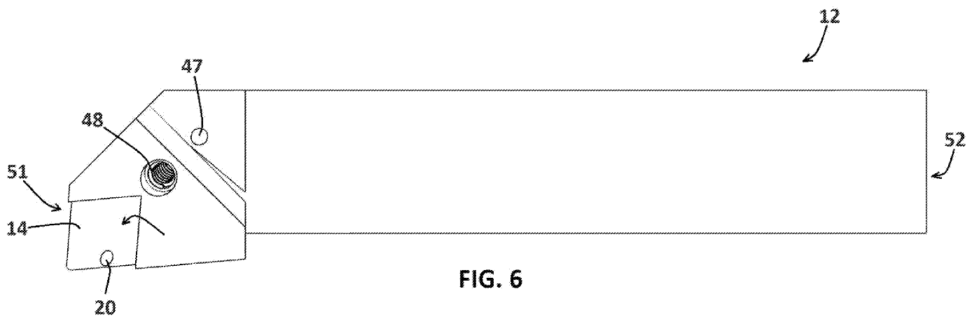

Referring now to the drawings with more specificity, the reader is firstly directed to FIGS. 1 through 4 generally depicting a first cutting tool 10 arrangement incorporating a cutting insert 11 according to the presently disclosed subject matter. The cutting insert 11 is securely mounted to a cutting tool holder 12 of the first cutting tool 10. It should be noted the cutting insert 11 according to the presently disclosed subject matter can be used in any type of cutting operation.

In some embodiments, the cutting insert 11 seats upon a base plate or insert seat 13 disposed between the cutting insert 11 and an apertured seat surface 14 of the cutting tool holder 12 within an insert space 50 formed at a first holder end 51 of the cutting tool holder 12. In some embodiments, the apertured seat surface 14 is angled relative to a bottom surface 46 of the cutting tool holder 12. It will be understood that features described herein with reference to and/or illustrated in the accompanying drawings, and/or recited in the appended claims, as constituting elements of the insert seat 13, may be provided on the cutting tool holder 12, and vice versa, and should not be construed as limiting.

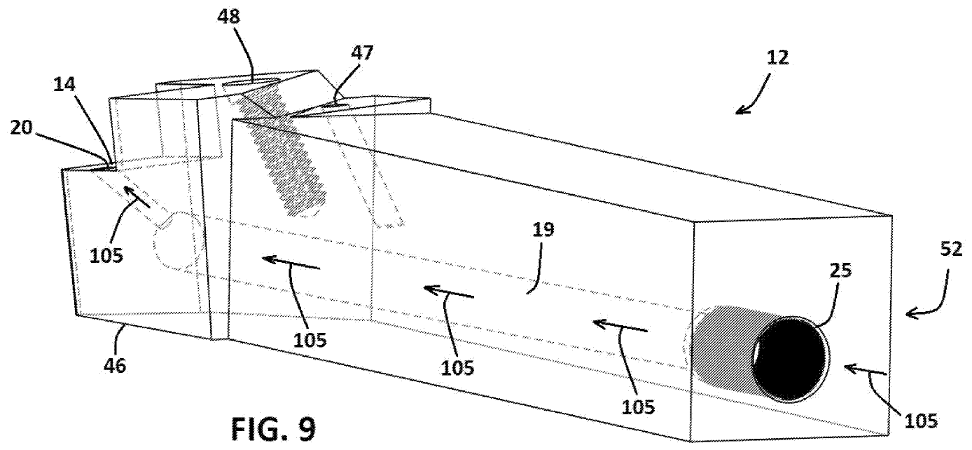

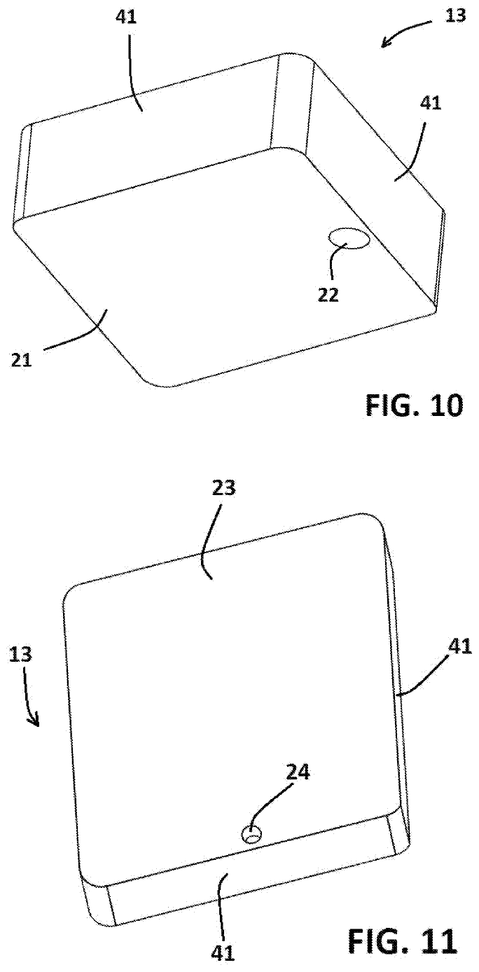

In some embodiments, the first cutting tool 10 further comprises a comprises a clamping device 15 attached to the cutting tool holder 12 by way of a fastener 16. Together, the clamping device 15 and fastener 16 securely attach the cutting insert 11 to the first cutting tool 10. In some embodiments the fastener 16 may be threaded and received in a threaded bore 48 as generally depicted and referenced in FIG. 9. In some embodiments, the cutting insert 11 is mounted to the cutting tool holder 12 atop the insert seat 13. In some embodiments, the clamping device 15 has a front tip 17 configured to be received in a mounting bore 18 formed in the cutting insert 11. The mounting bore 18 may be configured to enable a portion of a clamping device 15 to be received therein, while applying force on at least one of the sidewalls and/or bottom of the mounting bore 18, so as to fixedly attach the cutting insert 11 to the cutting tool holder 12 to which the clamping device 15 is also connected by way of the fastener 16 and a spring pin 49. The fastener 16 and the spring pin 49 are respectively received in bores 48 and 47 formed in the cutting tool holder 12 in some embodiments.

Notably, the first cutting tool 10 provides a cooling provisioning arrangement that cooperates with at least one cooling channel 31 provided by the cutting insert 11 to cool a corner cutting region 28 of the cutting insert 11. In some embodiments, the cutting insert 11 may comprise opposed cooling channels 31 for each corner cutting region 28. For purposes of these specifications, a first cooling channel 31 and a first corner cutting region 28 are discussed in detail, the details of which may further refer to analogous features of the cutting insert 11 as further specified as needed after the cooling channel 31 and the corner cutting region 28 are discussed.

Returning to the cooling provisioning arrangement according to the presently disclosed subject matter, the reader is directed to FIG. 9. Further referencing FIG. 9, the reader will there generally consider the cooling provisioning arrangement. The cooling provisioning arrangement comprises a conduit 19 that may extend along or through the length of the cutting tool holder 12, and has a coolant discharge aperture 20 at the apertured seat surface 14 at the first holder end 51. The first cutting tool 10 further provides a coolant inlet 25 at a second holder end 52 of the cutting tool holder 12. The coolant discharge aperture 20 is aligned with a through-bore formed in the insert seat 13 in those embodiments that include the insert seat 13.

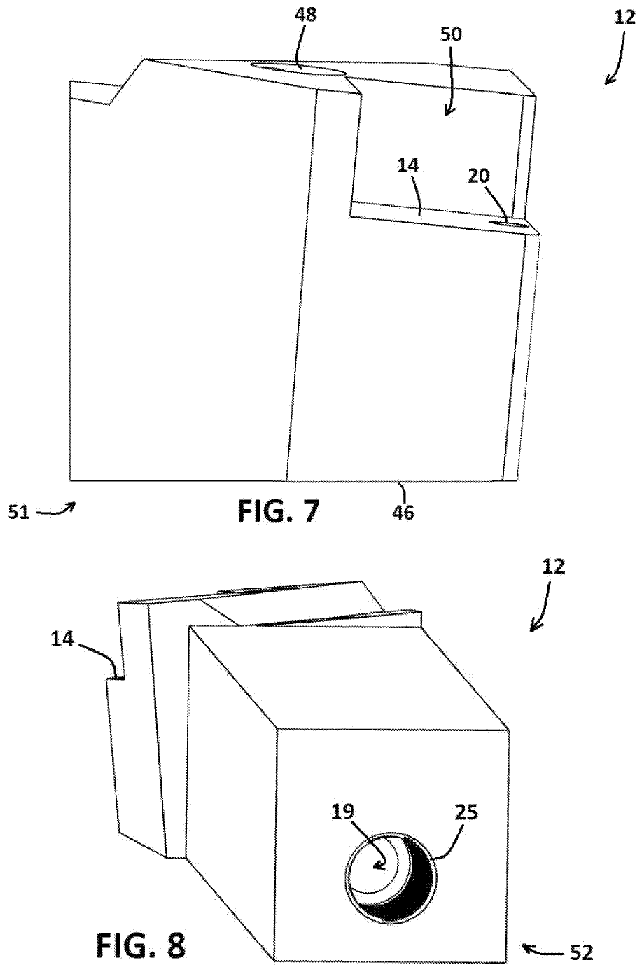

More particularly, a lower tool-facing surface 21 of the insert seat 13 bas a liquid inlet as at 22 and an upper insert-facing surface 23 of the insert seat 13 has a liquid outlet 24 in fluid communication with a coolant inlet 74 at an upstream section 30 of at least one cooling channel 31. In other words, the through bore interconnects the liquid inlet 22 and the liquid outlet 24, and the liquid outlet 24 is in fluid communication with the coolant inlet 74 of at least one cooling channel 31. Referencing FIG. 8, the reader will there consider a coolant path as at arrows 105 through the cutting tool holder 12. Coolant enters the cutting tool holder 12 at the coolant inlet 25 and is conducted via the conduit 19 to the coolant discharge aperture 20 or outlet formed in the apertured seat surface 14. When practiced with an insert seat 13, the liquid discharge aperture 20 is in fluid communication with the liquid inlet 22 of the insert seat 13, which liquid inlet 22 is in fluid communication with liquid outlet 24 of the insert seat 13 where it discharges coolant into at least one cooling channel 31 at an upstream section 30 of the cutting insert 11 downwardly adjacent the corner cutting region 28 of the cutting insert 11 for cooling the same.

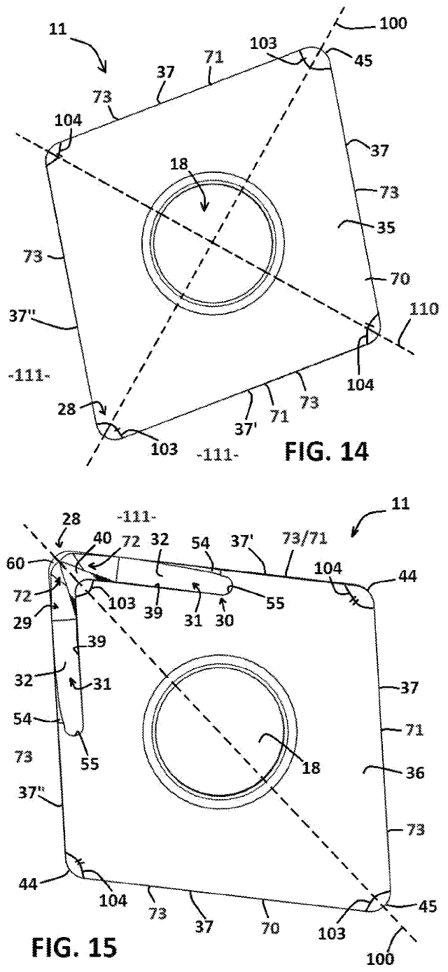

Central to the practice of the presently disclosed subject matter is the cutting insert 11. The cutting insert 11 according to the presently disclosed subject matter comprises a body 70 having an upper insert surface 35 defining an upper insert plane 109, a lower insert surface 36 defining a lower insert plane 108, and at least one sidewall 71 extending therebetween. In some embodiments, the cutting insert 11 comprises opposed side walls 71 extending opposite a frontal insert plane 110 as generally depicted and referenced in FIG. 14. In some embodiments each side wall 71 comprises two side wall portions as at 73 angled relative to one another about a medial insert plane 100. Accordingly, in some embodiments, the cutting insert 11 comprises two sidewalls 71 and four side wall portions 73. In some embodiments, the body 70 of the cutting insert 11 is rhombic or square having a series of sidewall surfaces 37 extending therebetween the upper insert surface 35 and the lower insert surface 36. The cutting insert 11 further comprises at least one corner cutting region 28 defined between at least one sidewall 71 and the upper insert surface 35 in some embodiments.

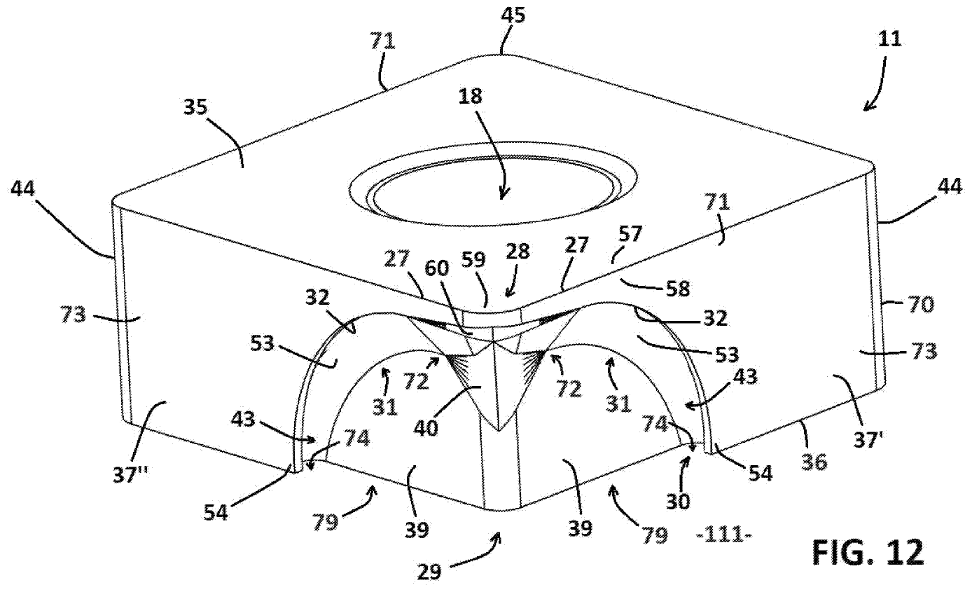

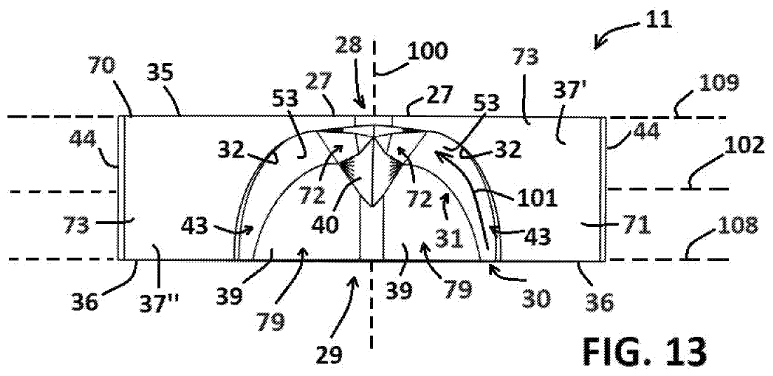

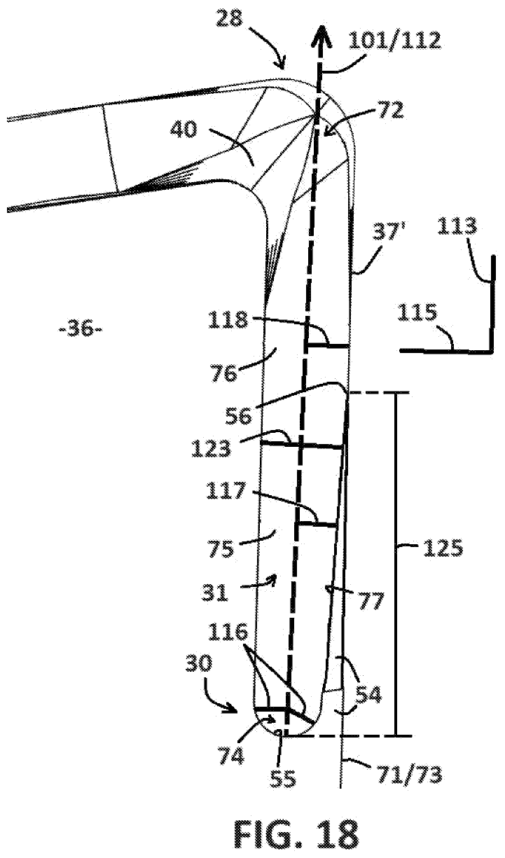

In some embodiments, at least one sidewall 71 is formed with at least one cooling channel 31 defining a coolant flow path 101 extending between an upstream section 30 thereof and having a coolant inlet 74 facing the lower insert plane 108. The cooling channel 31 further comprises a downstream section 72 extending beneath the corner cutting region 28. In some embodiments, the coolant flow path 101 is at least partially exposed to an exterior 111 of the cutting insert 11 as referenced in FIGS. 12, 14, and 15. The coolant channel 31 further comprises an arcuate portion 32 between the upstream section 30 and the downstream section 72. The coolant flow path 101 follows an imaginary median line 112 passing through the coolant flow path 101 depicted in broken lining in FIG. 18 to characterize the same. In some embodiments, the coolant flow path 101 is an arcuate path as generally depicted in FIGS. 13, 17, and 20.

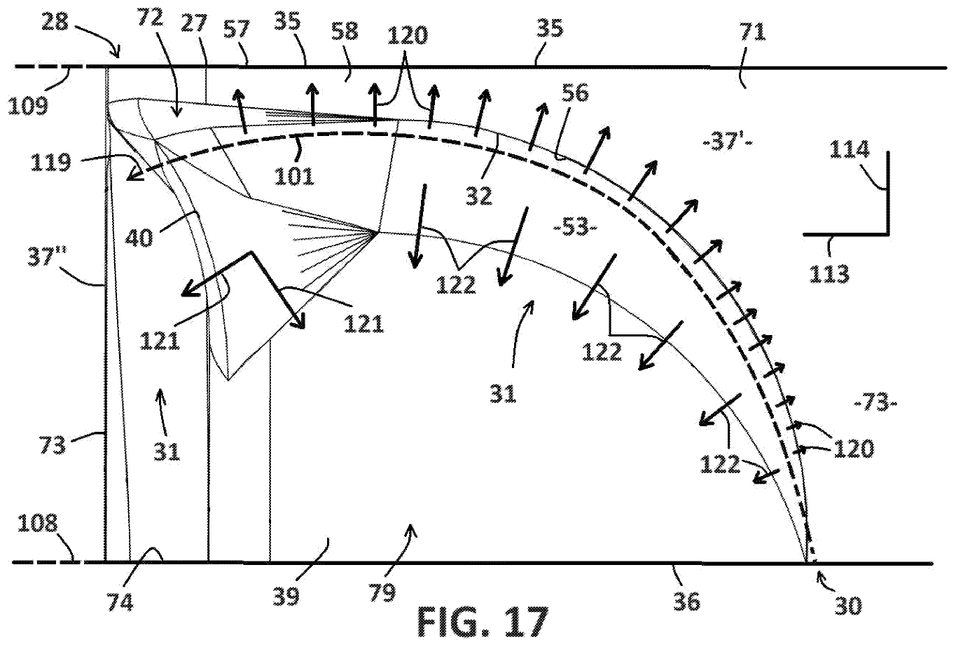

In some embodiments, the arcuate portion 32 is characterized by a single smooth curve along at least a portion of the coolant flow path 101 extending within a flow plane defined by the X axis 113 and the Y axis 114 as referenced in FIG. 17. Comparatively referencing FIG. 18, the reader will there see the coolant flow path 101 is linear along the imaginary median line 112 within the flow plane as defined along the X axis 113 and the Y axis extending into the page. The Z axis 115 is further referenced in FIG. 18 extending transverse to the sidewall 71 and sidewall portion 73 for aiding the reader's understanding. In some embodiments, the form of the arcuate portion 32 creates pressure in a coolant directed therealong due to centrifugal forces 120 directed radially outward from the coolant flow path 101 along the arcuate portion 32 thereby increasing coolant flow along the coolant flow path 101 for increasing heat removal at the corner cutting region 28 at the downstream section 72.

In some embodiments, the singe smooth curve defined by the arcuate portion 32 is radiused in three dimensions at least along a portion thereof. In this regard, the reader is further directed to FIGS. 17 and 18. Referencing FIG. 17, for example, the reader will there see the radius of the coolant flow path 101 at the upstream section 30 is maximized or virtually infinite such that no centrifugal forces 120 appear at the upstream section 30. In other words, the coolant flow path 101 is more linear at the upstream section 30. As the coolant flow path 101 progresses toward the downstream section 72, the radius of the arcuate portion 32 smoothly decreases corresponding to incrementally increasing centrifugal forces 120. Accordingly, in some embodiments, the single smooth curve comprises a decreasing radius at least along a portion of the coolant flow path 101 extending from the upstream section 30 toward the downstream section 72 corresponding to incrementally increasing centrifugal forces 120 along said portion of the coolant flow path 101.

Comparatively referencing FIG. 18, the reader will there further consider the upstream section 30 and the coolant flow path 101 therefrom. In some embodiments, the single smooth curve comprises an increasing radius in a dimension transverse to the coolant flow path 101 from the upstream section 30 toward the downstream section 72. More particularly, FIG. 18 depicts an inlet radius as at 116 at the coolant inlet 74. The arcuate portion 32 further comprises at least a first radiused portion 75 and at least a second radiused portion 76 downstream relative to the first radiused portion 75 along a length of the arcuate portion 32. The first radiused portion 75 has a radius 117 greater than the inlet radius 116, and the second radiused portion 76 has a radius 118 greater than the radius 117. The radii 116, 117, and 118 incrementally increase due to the sloped inner wall surface 77 of an external wall portion 54 extending along a wall length 125. In other words, the sloped inner wall surface 77 is obliquely angled to an inner cavity surface 39 of a wall cavity 79 in which the cooling channel 31 is formed. In some embodiments, the inner cavity surface 39 is parallel to an exterior sidewall surface 37 of the sidewall 71.

Returning to FIG. 17, the reader will there see the arcuate portion 32 extends through an arc length of at least 90 degrees along the coolant flow path 100 relative to the lower insert surface 36 and lower insert plane 108 in some embodiments. In some embodiments, the arcuate portion 32 extends through an arc length greater than 90 degrees along the coolant flow path 100 from the lower insert plane 108. In some embodiments, the arcuate portion 32 extends through an arc length ranging from 105 to 125 degrees from the lower insert plane 108. Accordingly, in some embodiments, the arcuate portion 32 is configured to direct coolant along the coolant flow path 101 downwardly as at 119 relative to the upper insert plane 109 at the corner cutting region 28 for enhancing heat removal at the corner cutting region 28 and directing coolant downwardly into a workpiece 26 during a cutting operation as described in more detail hereinafter.

As introduced above, it will be understood the cooling channel 31 is formed within a wall cavity 79 exposed to the exterior 111 of the cutting insert 11 and has an arcuate portion 32. The arcuate portion 32 directs coolant along the coolant flow path as at 101, which coolant flow path 101 follows median line 112. In some embodiments, the coolant flow path 101 is an arcuate path within the cooling channel 31 formed in the wall cavity 79. In other words, in some embodiments, the cooling channel 31, in fluid communication with the liquid outlet 24, is curved or arcuate in form at upper portions thereof such that coolant is applied with centrifugal force(s) 120 against the arcuate portion 32 to bring as much coolant volume as close as possible to a cutting edge 27 at the corner cutting region 28. The cooling channel 31 is essentially configured to extend between the upstream section 30 of the cutting insert 11 toward the downstream section 72 at the corner cutting region 28.

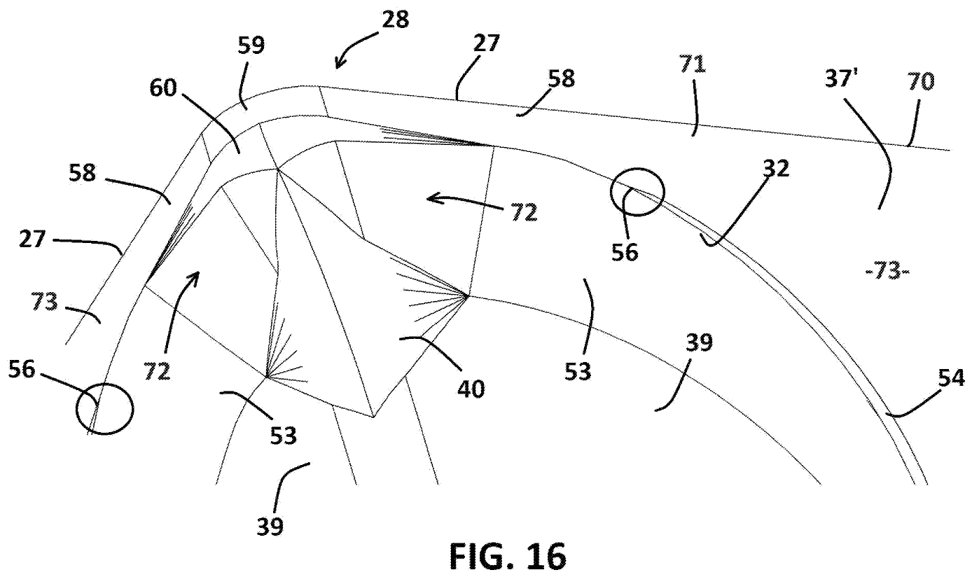

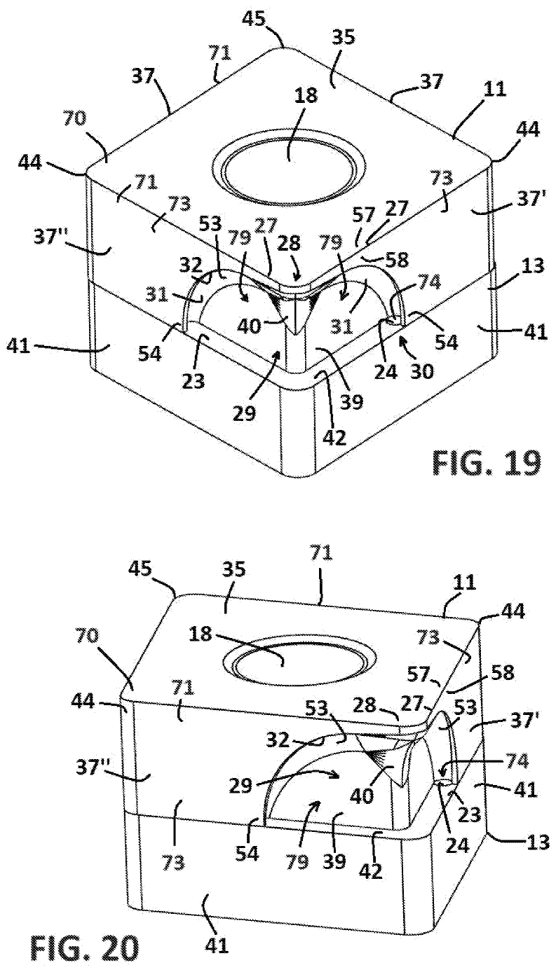

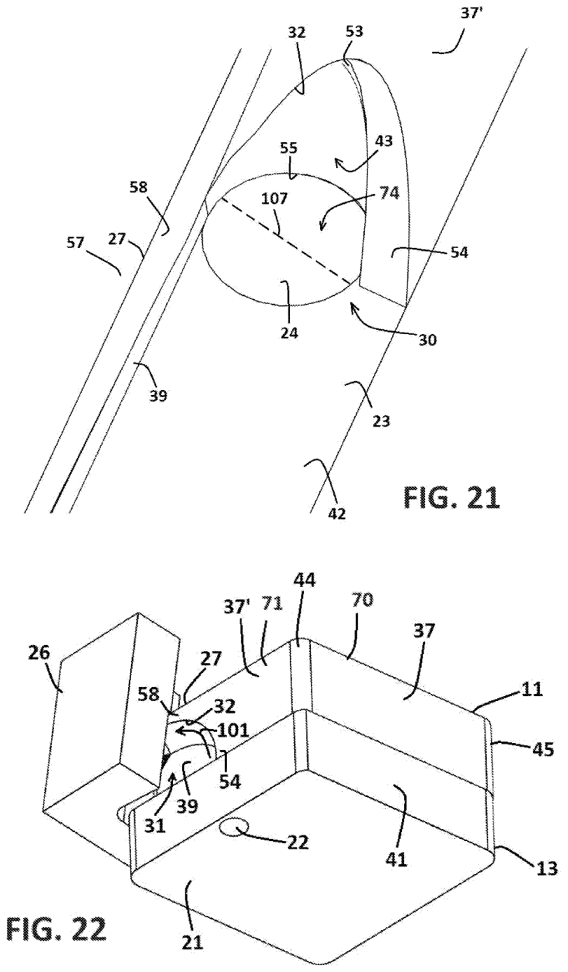

The cutting insert 11 according to the presently disclosed subject matter comprises at least one cutting edge 27 associated with the corner cutting region 28 of the cutting insert 11. Each cutting edge 27 is formed intermediate a rake surface as at 57 generally characterized by an upper insert face of the cutting insert 11 and a flank surface as at 58 generally characterized by upper portions of a sidewall surface 37′ of the sidewall 71 of the cutting insert 11 as generally and comparatively referenced in FIGS. 16-20. In some embodiments, the wall cavity 79 is associated with the corner cutting region 28 and formed therebeneath within the sidewall surface 37 defined inwardly relative to the exterior 111 by the inner cavity surface 39. The externally exposed wall cavity 79 is configured to draw heat from the cutting corner 28 during cutting operations of a workpiece 26.

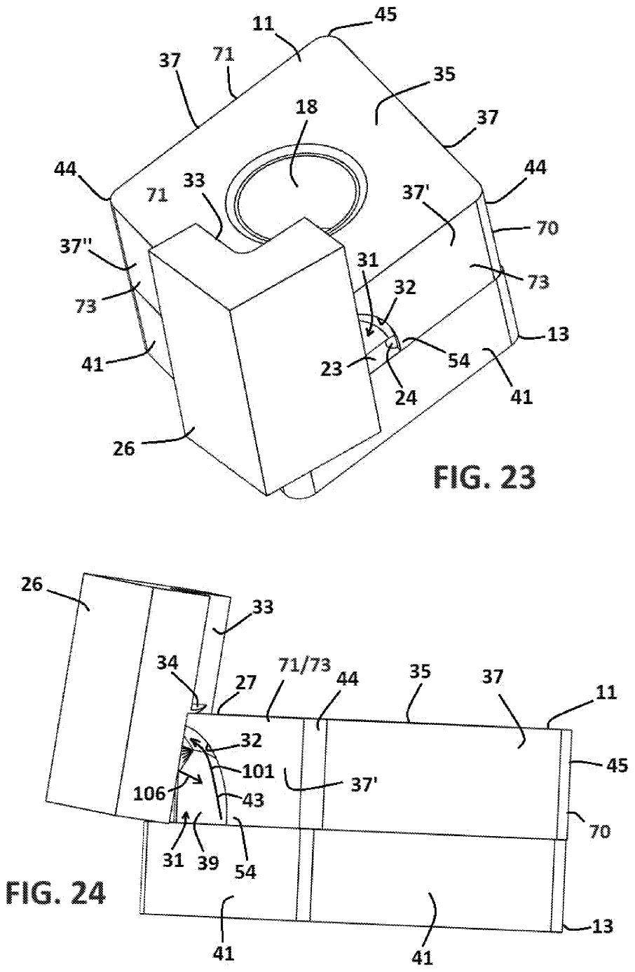

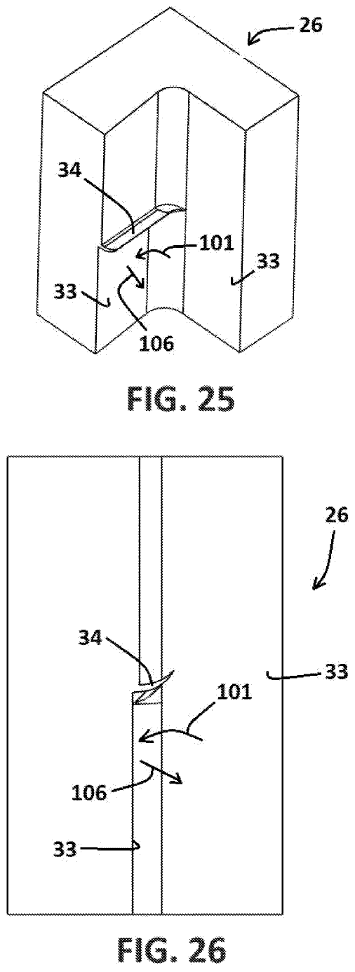

Stated another way, the corner cutting region 28 has at least one rake surface 57 at the upper insert surface 35 and at least one flank surface 58 at the sidewall surface 37′ thereby providing at least one cutting edge 27. In some embodiments, the cooling channel 31 extends from the flank surface 58 to the lower insert surface 36. In some embodiments, the externally exposed wall cavity 79 is configured to allow introduction of coolant thereinto during a cutting operation performed on a workpiece 26 as generally depicted and referenced in FIGS. 22 through 26. During such cutting operations, the corner cutting region 28 is continuously heated to high temperatures due to high friction between itself and the workpiece 26. The coolant is purposed to flow into the wall cavity 79 by way of the cooling channel 31 and thereby absorb and remove heat transferred thereto from the corner cutting region 28. As a result, the corner cutting region 28 is effectively cooled during the cutting operation and the wear occurring as a result of its operation is reduced.

The wall cavity 79 is positioned intermediate the corner cutting region 28 and the upper seat surface 23 of the insert seat 13 to enable the coolant to effectively withdraw heat from the corner cutting region 28. To enable effective extraction of heat from the cutting edge 27 and the corner cutting region 28, at least a part of the wall cavity 79 is disposed adjacent the corner cutting region 28, in the vicinity of the cutting edge 27 while being spaced therefrom, so as to minimize structural damage to and maintain structural integrity of the cutting edge 27. The cooling channel 31 formed in the wall cavity 79 is configured to receive coolant from the liquid outlet 24 of the insert seat 13 at the upstream section 30 for removing heat from the corner cutting region 28, the cutting edge 27 and, particularly, from structure of the cutting insert 11 disposed between the cutting edge 27 and the wall cavity 79.

In some embodiments, a majority of the coolant flow path 101 is exposed to the exterior 111 of the cutting insert 11. In this regard, the coolant inlet 74 at the upstream section 30 comprises or is defined in part by the external wall portion 54. Accordingly, in some embodiments, the upstream section 30 may comprise an external wall portion 54 defining the liquid inlet 74 and flanking the liquid outlet 24 for directing coolant into at the cooling channel 31 from the liquid outlet 24. In some embodiments, the upstream section 30 at the external wall portion 54 is continuous with the inner cavity surface 39 at a radiused portion 55.

In some embodiments, the radiused portion 55 may be configured to correspond with an outlet diameter 107 of the liquid outlet 24. In other words, the liquid inlet 74 comprises an inlet diameter that corresponds to the outlet diameter, in some embodiments. In some embodiments, the external wall portion 54 slopes toward the arcuate portion 32 becoming smooth therewith as at smooth transition point 56 intermediate the upstream section 30 and the downstream section 72 at the corner cutting region 28. In some embodiments, the downstream section 72 extends from the arcuate portion 32 toward a banked portion 40. It will be recalled, the arcuate portion 32 is designed for centrifugal application of coolant thereagainst thereby increasing coolant flow along the coolant flow path 101 at the corner cutting region 28 for removing heat therefrom. The banked portion 40 redirects coolant as at arrows 121 toward the workpiece 26 for absorbing heat therefrom.

In some embodiments, the majority of the coolant flow path 101 is exposed toward the downstream section 72 while a remainder or minority of the coolant flow path 101 is unexposed or enclosed at or adjacent the upstream section 30. In some embodiments, the upstream section 30 may be said to comprise the external wall portion 54, which flanks an outer portion of the coolant inlet 74 for directing coolant into the cooling channel 31 from the coolant outlet 24. In some embodiments, the external wall portion 54 incrementally slopes to the smooth transition point 26 such that a majority of the coolant flow path 101 is exposed to the exterior 111 of the cutting insert 11. In other words, in some embodiments, the coolant flow path 101 at the upstream section 30 is unexposed or enclosed as contained at the inner wall surface 77 of the external wall portion 54, which slopes toward the smooth transition point 56. The coolant flow path 101 may be said to comprise both exposed and enclosed portions along the coolant flow path 101 together forming a conjoined, exposed/enclosed coolant stream therealong. In some embodiments, the coolant flow path 101 becomes increasing exposed from the upstream section 30 toward the downstream section 72.

In some embodiments, the coolant inlet 74 comprises an inlet radius as at radius 116. In some embodiments, the external wall portion 54 is angled or sloped relative to the inner cavity surface 39 of the wall cavity 79 for increasing a coolant flow path width 123 relative to the inlet radius 116 as coolant is directed along the coolant flow path 101 toward the downstream section 72. In some embodiments, the upstream section 30 at the external wall portion 54 is radiused or dimensioned correspondingly with the diameter 107 of the coolant outlet 24 external to the cutting insert 11 and in fluid communication therewith. In some embodiments, the external wall portion 54 slopes toward the arcuate portion 32 becoming smooth therewith at the smooth transition point 56 intermediate the upstream section 30 and the downstream section 72 at the corner cutting region 28.

In some embodiments, the coolant flow path 101 may be further directed or affected by an arcuate banked portion 53 extending along the arcuate portion 32. In some embodiments, the arcuate banked portion 53 is sloped from the arcuate portion 32 toward the inner cavity surface 39 of the wall cavity 79 for directing coolant therealong as at arrows 122 in FIG. 17. The arcuate portion 32 terminates at the downstream section 72 at the medial insert plane 100 at the banked portion 40. In some embodiments, the banked portion 40 is centrally located at the medial plane 100, which further directions coolant flow as at arrows 121 toward the workpiece 26 and the wall cavity 79. In some embodiments, the cooling channel 31 is configured to cooperably oppose an inner workpiece surface 33 during a cutting operation to redirect coolant within a space defined between the inner workpiece surface 33 of a workpiece and the corner cutting region 28.

In some embodiments, as introduced hereinabove, the cutting insert 11 according to the presently disclosed subject matter may comprise at least one sidewall 71 comprising two sidewall portions 73 angled relative to one another. In some embodiments, the two sidewall portions 73 together define a bifurcated wall cavity 29 beneath the corner cutting region 28. In other words, the bifurcate wall cavity 29 comprises the wall cavities 79 in fluid communication with one another. In some embodiments, the cutting insert 11 comprises a corner cutting region 28 defined between two, first and second, adjacent sidewall surfaces as at 37′ and 37″ and the upper insert surface 35. In some embodiments, at least one cooling channel 31 is formed within the bifurcated wall cavity 29 at least a portion of which is exposed to the insert exterior 111. In some embodiments, opposed cooling channels 31 are formed in the bifurcated wall cavity 29.

In some embodiments, opposed cooling channels 31 in fluid communication with one another are formed in the bifurcated wall cavity 29. In some embodiments, the bifurcated wall cavity 29 is characterized by two opposed externally-exposed cooling channels 31 that symmetrically extend about the medial insert plane 100, which medial insert plane 100 extends orthogonally relative to the plane 102 of the cutting insert 11, diagonally intersecting the cutting insert 11 intermediate triangular lateral halves. In some embodiments, the opposed cooling channels 31 together define a bifurcated cooling channel flow path opposed portions of which are angled relative to one another and directed toward the corner cutting region 28 at least at the downstream section 72. In some embodiments, the medial insert plane 100 extends orthogonally relative to the upper insert surface 35 and the lower insert surface 36 and the bifurcated wall cavity 29 is symmetrical about the medial insert plane 100. In some embodiments, the opposed cooling channels 31 as formed in the bifurcated wall cavity 29 are symmetrical about the medial insert plane 100.

In some embodiments, the upper insert surface 35 of the cutting insert 11 is generally rhombic in form as generally depicted in FIG. 14. In these embodiments, the cutting insert 11 comprises acute angles 103 at the corner cutting region 28 and an insert corner 45 opposite the corner cutting region 28 with obtuse angles 104 at the laterally opposed corners 44 of the cutting insert 11. The medial insert plane 100 extends through the acute angles 103 at the corner cutting region 28 and the insert corner 45 in certain embodiments. In some embodiments, the cutting insert 11 can be of different shapes (e.g., square). In other words, while the illustrated shape of the cutting insert 11 has been depicted as being generally rhombic, the illustrated embodiment is exemplary and should not be construed as limiting.

In some embodiments, the corner cutting region 28 comprises opposed cutting edges 27 angled relative to one another. In some embodiments, the corner cutting region 28 comprises a curved cutting edge 59 between the opposed cutting edges 27. In some embodiments, the corner cutting region 28 comprises a tapered portion 60 above the corner banked portion 40 in spaced relation to the curved cutting edge 59. The coolant is further directed within the cooling channel(s) 31 such that at least a portion of an inner workpiece surface 33 contains or redirects coolant as at arrow 106 during a cutting operation in order to facilitate heat removal from the corner cutting region 28, the cutting edge(s) 27, and the workpiece 26.

Further referencing FIGS. 22 through 26, the reader will there consider the workpiece 26 being processed. It will be noted that during a cutting operation, the workpiece 26 itself contributes to containing or redirecting the coolant within the bifurcated wall cavity 29 as at arrow 106. The inner workpiece surface 33 of the workpiece 26 contains and/or redirects coolant flowing within the bifurcated wall cavity 29 as the cutting edge 27 removes chip(s) 34 from the workpiece 26. Depending on the dimensional characteristics of the workpiece 26, in some applications, the bifurcated wall cavity 29 may be at least partially open to the exterior of the cutting insert 11 so as to enable coolant to flow therefrom during cutting operations as generally depicted in FIGS. 24 through 26.

It will be appreciated that in the present disclosure and claims, terms relating to direction, such as top and bottom, upper and lower, up and down, etc., and similar/related terms, are used with reference to the accompanying drawings, unless indicated otherwise or clear from the context, and should not be construed as limiting. The terms “horizontal” with respect to a surface or line of an element, e.g., a cutting insert, normally means that the surface/line is generally horizontal when the element in its working orientation is located on a horizontal base, and the term “vertical” with respect to a surface/line of the element means that the surface/line is generally vertical when the element in its normal orientation is located on a horizontal base. The term ‘front’ (and similar terms) refers to a direction towards the workpiece 26 and the term ‘rear’ (and other similar terms) refers to a direction away from the workpiece 26.

As earlier described, the cutting insert 11 according to the presently disclosed subject matter may comprise an upper insert surface 35, a lower insert surface 36 and a plurality of sidewall surfaces 37 extending therebetween. In some embodiments, the upper insert surface 35 and the lower inset surface 36 may be horizontally oriented, and the sidewall surfaces 37 may be vertically oriented. The plurality of sidewall surfaces 37 include a first sidewall surface as at 37′ and a second sidewall surface as at 37″ adjacent to the first sidewall surface 37′. The corner cutting region 28 is defined between upper portions of the first sidewall surface 37′, upper portions of the second sidewall surface 37″ and corner portions of the horizontal upper insert surface 35. The bifurcated wall cavity 29 is disposed beneath the corner cutting region 28 with the arcuate upper portion(s) 32 of the opposed cooling channels 31 extending therebeneath. A rake surface 57 provided by the horizontal upper insert surface 35 and the flank surface 58 provided by upper portions of the first and second sidewall surfaces 37′ and 37″ may define opposed cutting edge(s) 27 in certain embodiments.

In some embodiments, at least the corner cutting region 28 may be coated with a first coating material having reduced thermal conductivity with respect to the corner cutting region 28 to provide greater endurance to heat at the corner cutting region 28 for reducing the effect of heat generated during the cutting process of the corner cutting region 28, and for increasing the effective lifetime of the cutting insert 11. In some embodiments, the wall cavities 79 and the bifurcated wall cavity 29 may have cooling surfaces as defined by the inner cavity surfaces 39, which can be free of the first coating material to achieve the opposite effect to enhance heat transfer between the coolant flowing within the wall cavities 79 and the bifurcated wall cavity 29 and the corner cutting region 28, i.e., to enhance thermal conductivity, and thereby to enhance heat absorption from the corner cutting region 28.

In some embodiments, the cutting insert 11 may further comprise a mounting component, e.g., mounting bore 18, configured for engaging certain fastening elements, e.g., clamping device 15 and fastener 16, by which the cutting insert 11 can be fixedly held on the cutting tool holder 12 and/or insert seat 13. The mounting bore 18 can be in the form of a vertical through bore and the fastening element can be in the form of a fastener 16 configured to be received therein and to be inserted into a corresponding fastener receiving bore 48 formed in the cutting tool holder 12. The mounting bore 18 is a centrally disposed through-bore extending between the horizontal upper insert surface 35 and the horizontal lower insert surface 36 of the cutting insert 11 and has an axis constituting a central axis of the cutting insert 11.

In some embodiments, the cutting insert 11 is double-sided having a corner cutting region 28 at least at a front end thereof defined at the intersection of associated areas of one of the horizontal upper and lower insert surfaces 35 and 36 and two adjacent sidewall surfaces 37′ and 37″. The cutting insert 11 has at least one cutting edge 27 in certain embodiments. In some embodiments, the cutting insert 11 may have different configurations and a number of indexable corner cutting regions 28 with cutting edges 27. For example, the cutting insert 11 can have indexable cutting edges at its upper insert surface 35, or can have a polygonal shape other than rhombic (e.g., square).

It should be understood that the description regarding at least one cutting edge 27 and its associated cooling channel(s) 31 should be considered as being applicable to each of the cutting edges 27 of the cutting insert 11. In other words, in some embodiments, the bifurcated wall cavity 29 may comprises opposed cooling channels 31, at least portions of which extend along the at least one cutting edge 27, while being spaced from the cutting edge 27. In the present description and claims, the term “channel” means a region having at least one coolant directing wall, at least a part of which is spaced from the remainder of the upper insert surface 35 associated with the cutting edge 27 in the direction towards the other lower insert surface 36. The cooling channels 31 according to the presently disclosed subject matter each have an arcuate upper portion 32 that directs coolant along an arcuate coolant flow path 101 within a respectively wall cavity 79 to function in a manner similar to a banked turn, with a substantially planar inner cavity surface 39 that extends substantially parallel to the sidewall surfaces 37′ and 37″.

As variously described, the corner cutting region 28 is positioned above opposed external cooling channels 31 that together form a bifurcated wall cavity 29 that may be described as a bifurcated cooling cavity 29 in some embodiments. Each cooling channel 31 has an upstream section 30 that is positioned above a liquid outlet 24 so as to provide fluid communication therebetween. The bifurcated cooling cavity or wall cavity 29 comprises a central corner banked portion as at 40, opposed arcuate portions as at 32, and opposed inner cavity surfaces as at 39. Each cooling channel 31 comprises a downstream section 72 extending away from the upstream section 30 towards the corner cutting region 28 and disposed along a cutting edge 27 in spaced relation thereto.

In some embodiments, the insert seat 13 may comprise two through bores for inletting coolant at analogous upstream sections 30 positioned above liquid outlets 24 for directing coolant toward the central banked portion 40 along the arcuate portions 32, and inner cavity surfaces 39. The cooling channel(s) 31, in particular the geometry and orientation relative to the upstream sections 30, can be configured so as to enable directional flow of the coolant along interior surfaces of the cooling channels 31 at a desired speed, for providing a sufficient amount of surface area exposed to the coolant, and for mitigating the amount of fluid escaping from the cooling channel(s) 31 as dependent on the dimensions of the workpiece 26, the inner workpiece surface 33 of which helps contain and/or redirect coolant flow as at arrow 106 within the bifurcated cooling cavity 29 as the cutting edge 27 or edges 27 remove chip(s) 34 from the workpiece 26. In some embodiments, the corner cutting region 28 may further comprise a curved cutting edge 59 between opposed cutting edges 27 In some embodiments, the corner cutting region 28 may comprise a tapered portion 60 above the corner banked portion in spaced relation to the curved cutting edge 59.

If an insert seat 13 is to be used for mounting of a cutting insert 11 to a cutting tool holder 12, such an insert seat 13 may have an insert-facing surface 23, upon which the corresponding cutting insert 11 can be mounted, a tool-facing surface 21, and basal sidewalls 41 extending therebetween. The insert-facing surface 23 may be formed correspondingly with the lower insert surface 36 and the sidewall surfaces 37 of the corresponding cutting insert 11. The insert-facing surface 23 can have at least one liquid outlet 24 formed therein configured to provide fluid communication with the upstream section 30 of at least one cooling channel 31. In some embodiments, the insert-facing surface 23 can have at least two liquid outlets 24 formed therein configured to provide fluid communication with the upstream sections 30 of opposed cooling channels 31 formed within the bifurcated cooling cavity or wall cavity 29. Corresponding through bores may formed in each such insert seat 13 to communicate the conduit 19 with the liquid outlets 24 in these embodiments.

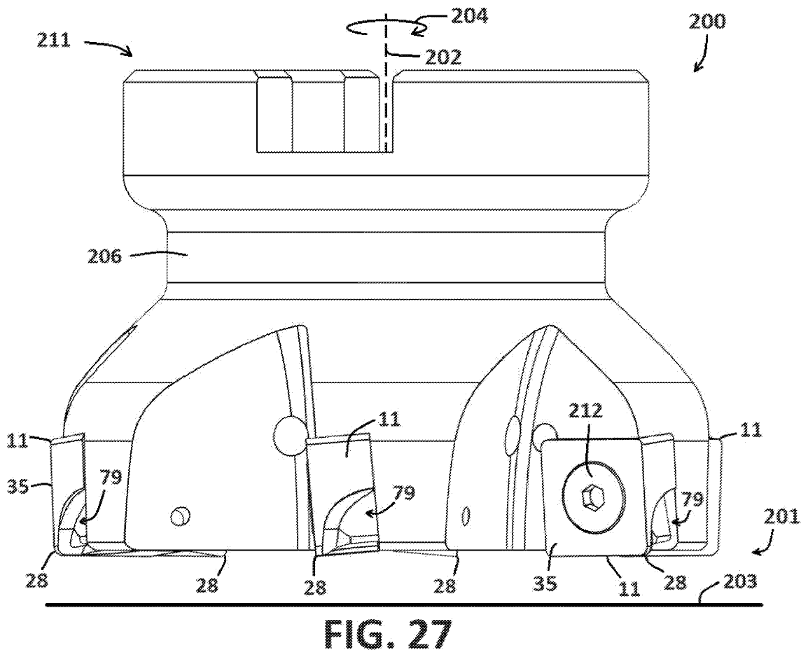

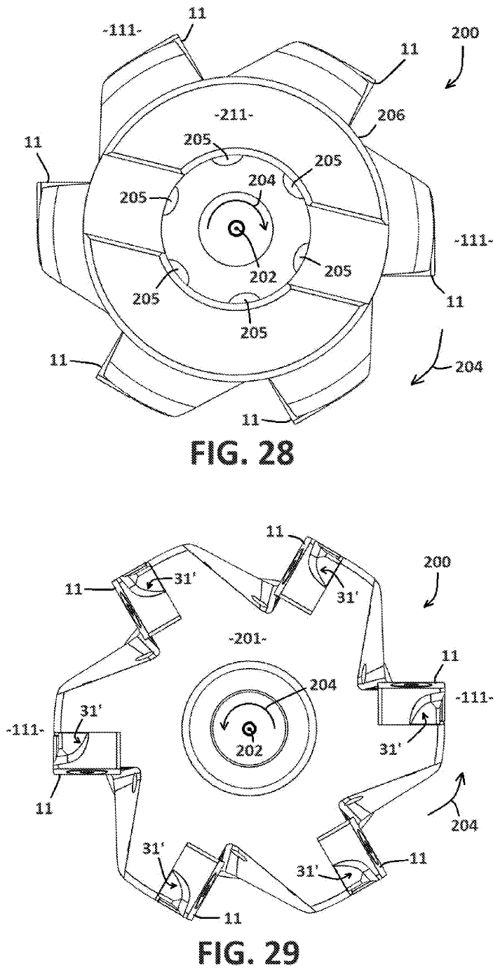

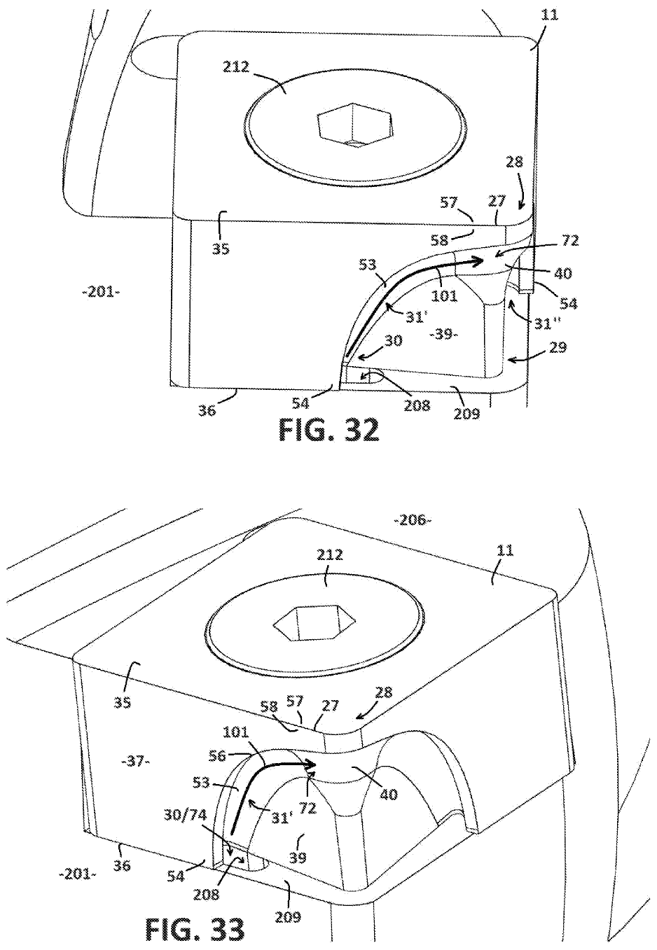

Referencing FIGS. 27-35, the reader will there consider a second cutting tool or milling tool 200 according to the presently disclosed subject matter. The milling tool 200 comprises an array of cutting inserts 11 arranged about a periphery of the milling tool 200 at a cutting end 201 thereof. In some embodiments, coolant may be directed into the milling tool 200 by way of a tool end 211 opposite the cutting end 201. The coolant then exits the milling tool 200 via the cutting inserts 11 at the cutting end 201 substantially as earlier described. In some embodiments, the milling tool 200 may rotate as at arrow 204 about a tool axis of rotation 202 such that the cutting inserts 11 may cut into a millable surface 203 for milling the same. In some applications, the cutting inserts 11 are suitable to be formed and utilized as positive cutting inserts 11 wherein a single, surface-facing cooling channel 31′ of each cutting insert 11 is operable to cool the cutting corner region 28 of each cutting insert 11 as it rotates 204 about the tool axis of rotation 202 into a millable surface 203.

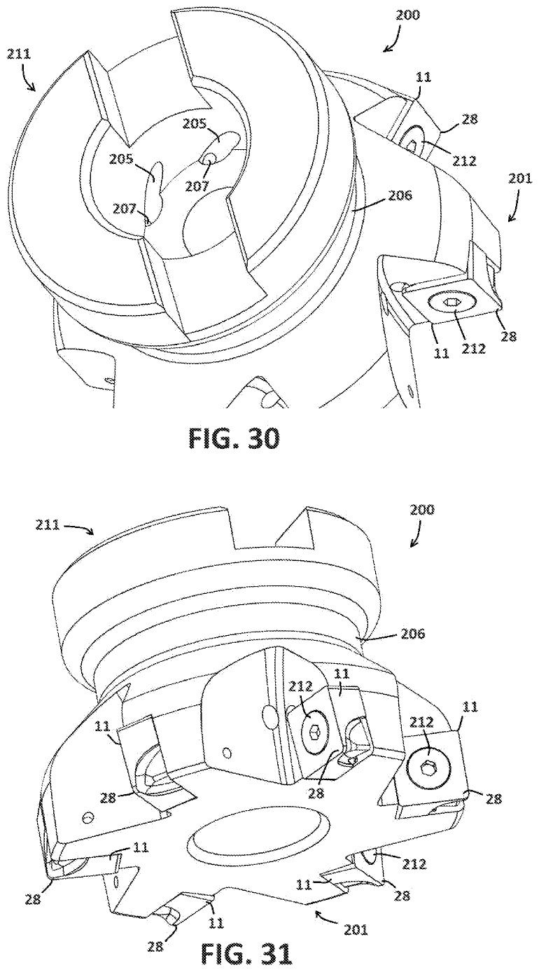

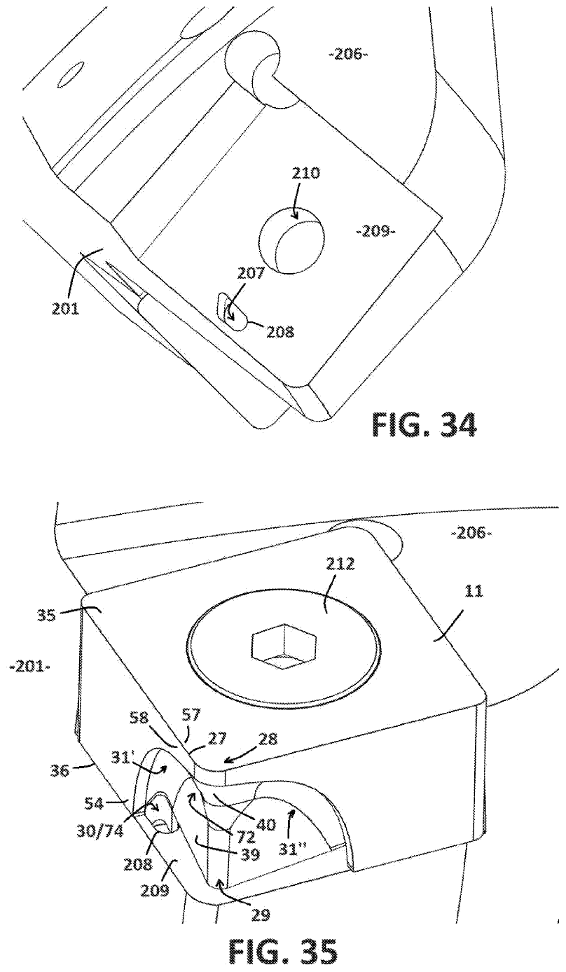

Referencing FIG. 30, the reader will there more particularly consider the tool end 211 of the milling tool 200. Coolant inlets 205 are formed in a main tool body 206 of the milling tool 200 at or adjacent the tooling end 211 in some embodiments. Coolant may be directed into the coolant inlets 205 and conducted toward the cutting end 201 via conduit pathways 207 formed in the main tool body 206 toward coolant outlets 208 formed in insert support portions 209 configured about the periphery of the milling tool 200 at the cutting end 201. Referencing FIG. 34, for example, the reader will there consider a substantially planar insert support portion 209 configured to support a lower insert surface 36 of the cutting insert with a single coolant outlet 208 formed therein.

In some embodiments, the cutting inserts 11 are mounted to the insert support portions 209 such that the coolant inlets 74 at the upstream sections 30 of the surface-facing cooling channels 31′ are aligned with the coolant outlets 208 of the insert support portions 209. In some embodiments, the insert support portions 209 further comprise a fastener-receiving aperture 210 that cooperate with the mounting bores 18 formed in the cutting inserts 11. A fastener 212 securely fastens a respective cutting insert 11 to a respective insert support portion 209 via the coaxially aligned fastener-receiving aperture 210 and mounting bore 18.

In other words, in some embodiments, each cutting insert 11 mountable to the milling tool 200 is suitable to be formed and used as a positive cutting insert having a singular cutting edge 27 at the corner cutting region 28 opposing the millable surface 203. The array of cutting inserts 11 of the milling tool 200 are arranged and configured such that the coolant may be directed into a surface-facing cooling channel 31′ facing the millable surface 203 of the milling tool 200 generally extending transversely relative to the tool axis of rotation 202. Coolant enters the surface-facing cooling channels 31′ at the upstream sections 30 of the cutting inserts 11 and is directed along the coolant flow paths 101 toward the corner cutting regions 28 of the cutting, inserts 11 for cooling the corner cutting regions 28 as the milling tool 200 mills or cuts the millable surface 203.

In some embodiments, exterior-facing cooling channels 31″ facing the exterior 111 and extending substantially parallel relative to the tool axis of rotation 202 are not necessarily configured to direct coolant thereinto for directing coolant toward the centralized corner cutting regions 28. In other words, in some applications, the exterior-facing cooling channels 31″ are not configured to comprise coolant inlets aligned with coolant outlets formed in the insert support portions 209 of the milling tool 200. This being said, the bifurcated wall cavities 29 in adjacency to the corner cutting regions 28 may still enable coolant to enter the spaces defined by both the surface-facing cooling channels 31′ and the exterior-facing cooling channels 31″ for nevertheless aiding heat transfer from the corner cutting region 28. The cutting inserts 11 of the milling tool 200 are otherwise configured to operate substantially as earlier described hereinabove in some embodiments.

1-39. (canceled)

40. A cutting insert, comprising:
a body having an upper insert surface;
a lower insert surface defining a lower insert plane; and
at least one sidewall extending therebetween, and comprising at least one corner cutting region defined between the at least one sidewall and the upper insert surface;
said at least one sidewall being formed with at least one cooling channel defining a coolant flow path extending between an upstream section thereof having a coolant inlet facing said lower insert plane, and a downstream section thereof extending beneath said at least one corner cutting region, said coolant flow path, being at least partially exposed to an exterior of the cutting insert comprising an arcuate portion between the upstream section and the downstream section,
wherein said sidewall comprises opposed sidewall portions angled relative to one another,
wherein the opposed sidewall portions together defining a bifurcated wall cavity beneath the corner cutting region, and
wherein the bifurcated wall cavity comprising two of said cooling channels, being opposed and in fluid communication with one another.

41. The cutting insert according to claim 40, wherein the arcuate portion is characterized by a single smooth curve along at least a portion of the coolant flow path.

42. The cutting insert according to claim 41, wherein the single smooth curve extends along a planar dimension parallel to said sidewall.

43. The cutting insert according to claim 40, wherein the arcuate portion creates pressure in a coolant directed therealong, thereby increasing coolant flow along the coolant flow path for increasing heat removal at the corner cutting region.

44. The cutting insert according to claim 43, wherein the arcuate portion comprises a decreasing radius at least along a portion of the coolant flow path extending from the upstream section toward the downstream section corresponding to an increasing centrifugal force along said portion of the coolant flow path.

45. The cutting insert according to claim 44, wherein the arcuate portion comprises an increasing radius in a dimension transverse to the coolant flow path from the upstream section toward the downstream section.

46. The cutting insert according to claim 40, wherein the arcuate portion extends through an arc length at least 90 degrees along the coolant flow path.

47. The cutting insert according to claim 40, wherein the arcuate portion is configured to direct coolant along the coolant flow path downwardly at the corner cutting region for enhancing heat removal thereat.

48. The cutting insert according to claim 40, wherein said cooling channel is formed in a wall cavity at least a portion of which is exposed to the exterior of the cutting insert.

49. The cutting insert according to claim 48, wherein a majority of said coolant flow path is exposed to the exterior of the cutting insert.

50. The cutting insert according to claim 49, wherein the majority of said coolant flow path is exposed toward the downstream section and a minority of said coolant flow path is enclosed toward the upstream section.

51. The cutting insert according to claim 50, wherein the coolant flow path at the upstream section is enclosed relative to the exterior, the coolant flow path thereby comprising exposed and enclosed portions therealong together forming a conjoined coolant stream.

52. The cutting insert according to claim 48, wherein the coolant inlet comprises an inlet radius, an external wall portion encloses the coolant inlet at the upstream section and is sloped relative to the coolant inlet for increasing a coolant flow path width relative to the inlet radius as coolant is directed along the coolant flow path toward the downstream section.

53. The cutting insert according to claim 48, further comprising an arcuate banked portion extending along the arcuate portion and being sloped therefrom toward an inner cavity surface of the wall cavity for directing coolant therealong.

54. The cutting insert according to claim 40, wherein the corner cutting region comprises a corner banked portion configured to redirect coolant beneath the corner cutting region.

55. The cutting insert according to claim 40, wherein the opposed cooling channels together define a bifurcated cooling channel flow path with opposed portions which are angled relative to one another and directed toward the corner cutting region.

56. The cutting insert according to claim 40, wherein a medial insert plane extends orthogonally relative to said upper and lower insert surfaces, the bifurcated wall cavity being symmetrical about the medial insert plane.

57. The cutting insert according to claim 40, wherein the opposed cooling channels formed in the bifurcated wall cavity are symmetrical about the medial insert plane.

58. The cutting insert according to claim 53, wherein the inner cavity surface extends in parallel relation to a sidewall surface of the sidewall, said comer cutting region comprises a rake surface at the upper insert surface and a flank surface at the sidewall surface thereby providing at least one cutting edge at the upper insert surface.

59. The cutting insert according to claim 40, wherein at least one cooling channel extends from the flank surface to the lower insert surface.
